(19) United States
(12) Patent Application Publication
(10) Pub. No.: US 2019/0007593 A1
(43) Pub. Date: Jan. 3, 2019

(54) IMAGE CAPTURING APPARATUS, CONTROL METHOD FOR THE SAME, AND STORAGE MEDIUM

(71) Applicant: CANON KABUSHIKI KAISHA, Tokyo (JP)

(72) Inventor: Takeshi Watanabe, Tokyo (JP)

(21) Appl. No.: 16/019,683

(22) Filed: Jun. 27, 2018

(30) Foreign Application Priority Data
Jul. 3, 2017 (JP) 2017-130519

(51) Int. Cl. H04N 5/235; H04N 9/68

(52) U.S. Cl. CPC H04N 5/2353; H04N 9/68; H04N 5/2351

(57) ABSTRACT

An image capturing apparatus includes an image capturing unit configured to capture an image of an object, a calculation unit configured to extract a maximum luminance value of the object from an image signal that is output from the image capturing unit, and to calculate an object luminance value representing the maximum luminance value of the object with absolute luminance, and an exposure control unit configured to control exposure of the image capturing unit such that an image capture maximum luminance value, which is a maximum value of the absolute luminance capable of being captured with the image capturing unit, is greater than or equal to the object luminance value.

### BACKGROUND OF THE INVENTION

### Field of the Invention

The present invention relates to an image capturing apparatus that is able to perform image capture with an exposure suited to a display device capable of display with absolute luminance.

### Description of the Related Art

Conventionally, the output dynamic range of a display device such as a television or a monitor was narrow, and tones could only be represented in a fairly narrow range compared with the actual object. Thus, when an object was captured with an image capturing apparatus, processing for compressing a video signal having a wide dynamic range so as be squeezed into the dynamic range of the display device was needed. In the case where such processing is performed, there is a problem in that the video is displayed on the display device in a different state to how it looked and immediacy is lost.

Through technical innovation in recent years, the maximum luminance that can be represented by display devices has been greatly improved, and the dynamic range of tones of an image that can be represented has been expanded, so much so that representation of a dynamic range that covers the greater part of human visual characteristics is now within reach. The conversion characteristics of display devices for displaying extended dynamic range images have been standardized as SMPTE ST 2084:2014, following improvements in the dynamic range that can be represented by display devices.

Report ITU-R BT.2246-1 (August 2012) entitled “The present state of ultra high definition television” scientifically verifies that the JND (Just Noticeable Difference) that can be noticed with human visual characteristics differs according to the luminance. SMPTE ST 2084:2014 standardizes code values of video signals in association with luminance values that are displayed by a display device, based on this finding. Thus, it is expected that video signals that are input to a display device will undergo photoelectric conversion based on an inverse function of the conversion characteristics of the display device.

According to the standard defined in SMPTE ST 2084:2014, the code value of the image is displayed in association with absolute luminance at the time of image output to the display device. Thus, at the time of image capture, it is necessary to perform image capture with an awareness of the output luminance range of the display device and the luminance range of tones that can be represented at the time of image capture.

Here, Japanese Patent Laid-Open No. 2005-191985 discloses a method for displaying luminance information of the object with absolute luminance as a histogram, and the user is able to operate camera settings such as exposure while viewing the absolute brightness information of the object.

However, thinking about absolute luminance in association with the exposure settings of the camera on the spot requires knowledge and experience, and is difficult for general users. Although it is also conceivable for the camera to automatically perform exposure control, conventionally with typical AE (Auto Exposure) control, the primary focus is placed on controlling the main object to be at a relatively appropriate brightness. Thus, it is difficult to determine the exposure based on the absolute luminance of the object.

### SUMMARY OF THE INVENTION

The present invention has been made in view of the abovementioned problems, and provides an image capturing apparatus that is able to perform image capture with an exposure suited to the characteristics of a display device capable of display with absolute luminance.

According to a first aspect of the present invention, there is provided an image capturing apparatus comprising: at least one processor or circuit configured to perform the operations of the following units: an image capturing unit configured to capture an image of an object; a calculation unit configured to extract a maximum luminance value of the object from an image signal that is output from the image capturing unit, and to calculate an object luminance value representing the maximum luminance value of the object with absolute luminance; and an exposure control unit configured to control exposure of the image capturing unit such that an image capture maximum luminance value, which is a maximum value of the absolute luminance capable of being captured with the image capturing unit, is greater than or equal to the object luminance value.

According to a second aspect of the present invention, there is provided an image capturing apparatus comprising: at least one processor or circuit configured to perform the operations of the following units: an image capturing unit configured to capture an image of an object; a calculation unit configured to extract a reference luminance value of the object from an image signal that is output from the image capturing unit, and to calculate an object luminance value representing the reference luminance value of the object with absolute luminance; and an exposure control unit configured to control exposure of the image capturing unit, such that a position of the object luminance value between a minimum absolute luminance value and a maximum absolute luminance value of the object substantially coincides with a position of the object luminance value between a minimum value and a maximum value of an absolute luminance value capable of being captured with the image capturing unit.

According to a third aspect of the present invention, there is provided a method for controlling an image capturing apparatus that includes an image capturing unit configured to capture an image of an object, the method comprising: extracting a maximum luminance value of the object from an image signal that is output from the image capturing unit, and calculating an object luminance value representing the maximum luminance value of the object with absolute luminance; and controlling exposure of the image capturing unit such that an image capture maximum luminance value, which is a maximum value of the absolute luminance capable of being captured with the image capturing unit, is greater than or equal to the object luminance value.

According to a fourth aspect of the present invention, there is provided a method for controlling an image capturing apparatus that includes an image capturing unit configured to capture an image of an object, the method comprising: extracting a reference luminance value of the object from an image signal that is output from the image capturing unit, and calculating an object luminance value representing the reference luminance value of the object with absolute luminance; and controlling exposure of the image capturing unit, such that a position of the object luminance value between a minimum absolute luminance value and a maximum absolute luminance value of the object substantially coincides with a position of the object luminance value between a minimum value and a maximum value of an absolute luminance value capable of being captured with the image capturing unit.

Further features of the present invention will become apparent from the following description of exemplary embodiments with reference to the attached drawings.

### BRIEF DESCRIPTION OF THE DRAWINGS

FIG. 1 is a block diagram showing an internal configuration of a digital video camera which is a first embodiment of an image capturing apparatus of the present invention.

FIG. 2 is a block diagram showing an internal configuration of an image processing unit in the first embodiment.

FIG. 3 is a flowchart showing the flow of operations of the image processing unit in the first embodiment.

FIG. 4 is a flowchart showing the flow of operations of code conversion processing in the first embodiment.

FIGS. 5A to 5C are diagrams showing input/output characteristics of a display device in the first embodiment.

FIG. 6 is a flowchart showing the flow of operations of exposure control processing in the first embodiment.

FIG. 7 is a diagram illustrating the state of image data in an exposure evaluation value generation unit in the first embodiment.

FIGS. 8A to 8C are timing charts illustrating operations of exposure control processing in the first embodiment.

FIGS. 9A and 9B are diagrams illustrating operations of the image processing unit in the first embodiment.

FIG. 10 is a flowchart showing the flow of operations of an image processing unit in a second embodiment.

FIG. 11 is a diagram illustrating an input operation in the second embodiment.

FIGS. 12A to 12C are timing charts illustrating operations of exposure control processing in the second embodiment.

FIG. 13 is a flowchart showing the flow of exposure control processing in a third embodiment.

### DESCRIPTION OF THE EMBODIMENTS

Hereinafter, embodiments of the present invention will be described in detail, with reference to the accompanying drawings.

### First Embodiment

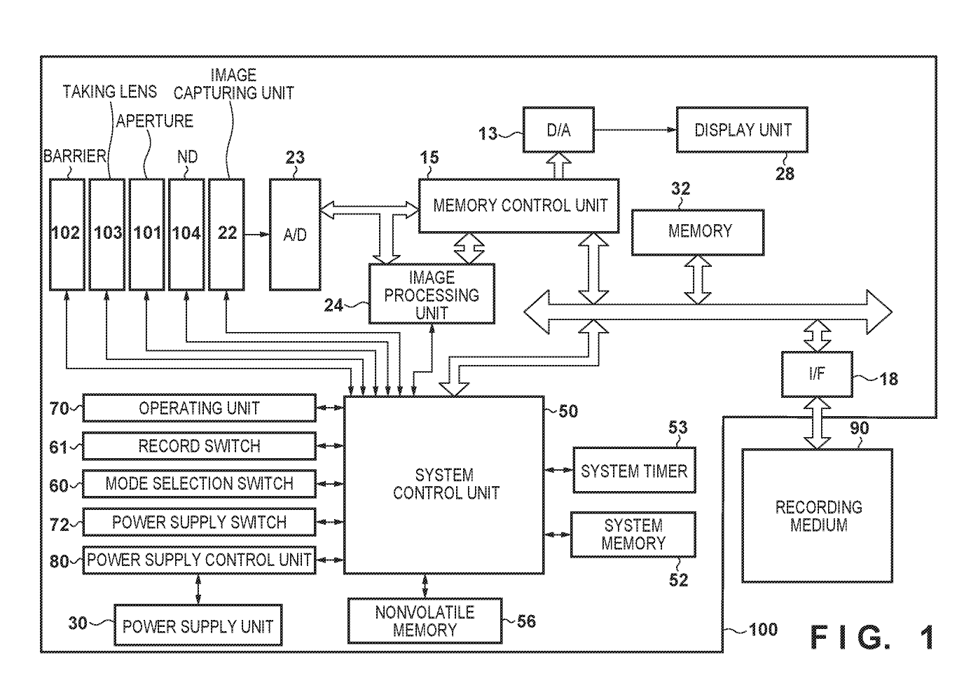

FIG. 1 is a block diagram showing an internal configuration of a digital video camera 100 which is a first embodiment of an image capturing apparatus of the present invention.

In FIG. 1, a taking lens 103 is a lens group that includes a zoom lens and a focusing lens, and forms an object image on an image capturing surface. An aperture 101 is an aperture that adjusts the amount of light that is projected onto the image capturing surface. An ND filter 104 is a ND filter that is used for light reduction. An image capturing unit 22 has an image sensor that is constituted by a CCD sensor, a CMOS sensor or the like that converts an optical image into an electrical signal (image signal). The image capturing unit 22 is also provided with a function of controlling the exposure time using an electronic shutter, and functions such as analog gain processing and changing the readout speed. An A/D convertor 23 converts the analog signal that is output from the image capturing unit 22 into a digital signal. A barrier 102, by covering an image capturing system that includes the taking lens 103 of the digital video camera 100, prevents the image capturing system that includes the taking lens 103, the aperture 101 and the image capturing unit 22 from being contaminated or damaged.

An image processing unit 24 performs processing such as color conversion, gamma correction and addition of digital gain on the data obtained by performing A/D conversion on the image signal of the image capturing unit 22 that is transferred from the A/D convertor 23 or a memory control unit 15. Also, predetermined computational processing is performed using captured image data, and the computation result is transmitted to a system control unit 50. The system control unit 50 performs controls such as ranging control, exposure control and white balance control based on the transmitted computation result. Processing such as AF (autofocus) employing a TTL (through-the-lens) method, AE (automatic exposure) and AWB (automatic white balance) is thereby performed. The image processing unit 24 will be discussed in detail later.

The video data that is output from the A/D convertor 23 is written directly to a memory 32 via the memory control unit 15 or via the image processing unit 24 and the memory control unit 15. The memory 32 stores image data captured by the image capturing unit 22 and converted into digital data by the A/D convertor 23 and image data for display on a display unit 28. The memory 32 is provided with sufficient storage capacity to store moving images and audio of a predetermined length.

The memory 32 also serves as a memory (video memory) for image display. A D/A converter 13 converts data for image display that is stored in the memory 32 into an analog signal and supplies the analog signal to the display unit 28. Image data for display written in the memory 32 is thus displayed by the display unit 28 via the D/A converter 13. The display unit 28 performs display that depends on the analog signal from the D/A converter 13 on a display such as an LCD. By performing analog conversion in the D/A converter 13 on digital signals that have undergone A/D conversion by the A/D convertor 23 and been stored in the memory 32, and sequentially transferring the analog signals to the display unit 28 to be displayed, an electronic viewfinder function can be realized and through-image display can be performed.

A nonvolatile memory 56 is a memory that is electrically erasable and recordable, and an EEPROM, for example, is used. Constants, programs and the like for use in operations of the system control unit 50 are stored in the nonvolatile memory 56. A program as referred to here is a computer program for executing various flowcharts which will be discussed later in the embodiments of the present invention.

The system control unit 50 performs overall control of the digital video camera 100. The system control unit 50 realizes the respective processing which will be discussed later, by executing programs recorded in the aforementioned nonvolatile memory 56. A RAM is used for a system memory 52, and constants and variables for use in operations of the system control unit 50, programs read out from the nonvolatile memory 56 and the like are expanded therein. The system control unit 50 also performs display control by controlling the memory 32, the D/A converter 13, the display unit 28 and the like.

A system timer 53 is a clocking unit that measures time that is used in various controls and time for a built-in clock. A mode selection switch 60, a record switch 61 and an operating unit 70 are operating units for inputting various types of operation instructions to the system control unit 50.

The mode selection switch 60 switches the operation mode of the system control unit 50 to one of a moving image recording mode, a still image recording mode, a playback mode and the like. Modes that are included in the moving image recording mode and still image recording mode are an auto shooting mode, an auto scene discrimination mode, a manual mode, various scene modes whose shooting settings are shooting scene specific, a programmed AE mode, a custom mode and the like. One of these modes that are included in the moving image shooting mode is directly switched to using the mode selection switch 60. Alternatively, a configuration may be adopted in which, after switching to the moving image shooting mode using the mode selection switch 60, another operating member is used to switch to one of these modes that are included in the moving image shooting mode. The record switch 61 switches between a shooting standby state and a shooting state. The system control unit 50 starts a series of operations from signal readout from the image capturing unit 22 to writing of moving image data to a recording medium 90, in response to operation of the record switch 61.

The operating members of the operating unit 70 are each appropriately allocated a function according to the scene, and operate as various function buttons, by performing an operation of selecting from among various function icons that are displayed on the display unit 28. The function buttons include, for example, a finish button, a return button, an image send button, a jump button, a stop-down button and an attribute modification button. For example, a menu screen that can be variously set is displayed on the display unit 28 when a menu button is pressed. A user is able to perform various settings intuitively using the menu screen displayed on the display unit 28, and up, down, left and right direction keys and a set button. Also, the operating unit 70 may be a touch panel that is operated by touching a panel disposed so as to be overlaid on the display unit 28.

A power supply control unit 80 is constituted by a battery detection circuit, a DC/DC converter, a switch circuit that switches the block to be energized and the like, and detects whether or not a battery is mounted, the type of battery, and the remaining battery amount. Also, the power supply control unit 80 controls the DC/DC converter based on the detection result thereof and instructions of the system control unit 50, and supplies a required voltage to the respective parts including the recording medium 90 for a required period. A power supply unit 30 consists of a primary battery such as an alkaline battery and a lithium battery, a secondary battery such as a NiCd battery, a NiMH battery and a Li ion battery, an AC/DC adaptor, and the like. An I/F 18 is an interface with the recording medium 90 such as a memory card or a hard disk, or an external display device. FIG. 1 shows the state when the recording medium 90 is connected. The recording medium 90 is a recording medium such as a memory card for recording captured images, and is constituted by a semiconductor memory, a magnetic disk or the like.

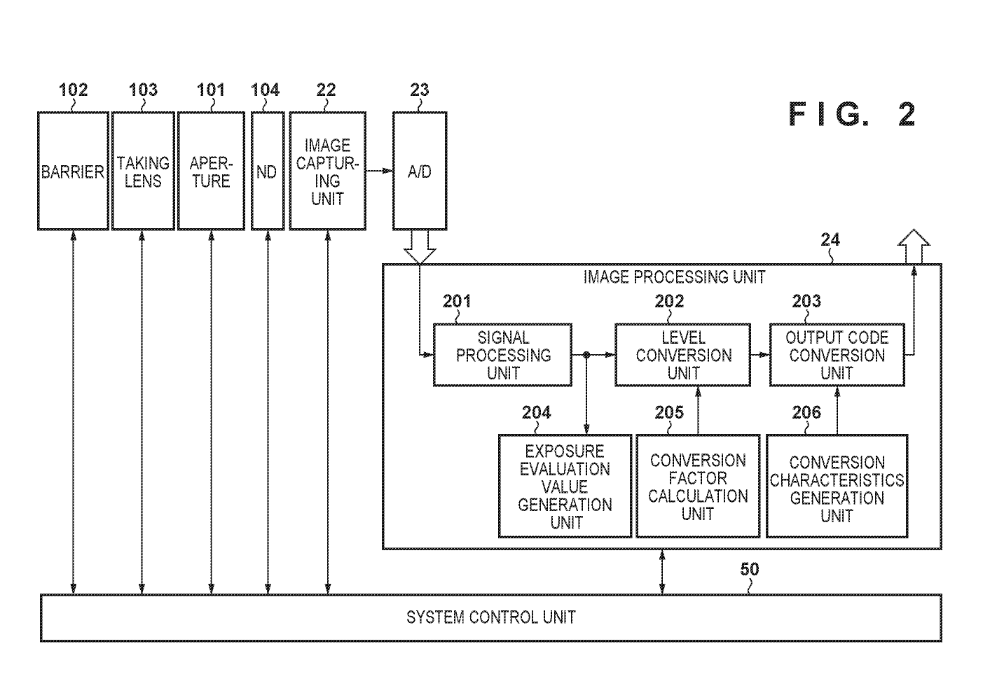

Next, an internal configuration of the image processing unit 24 in this embodiment will be described. FIG. 2 is a block diagram showing the internal configuration of the image processing unit 24 and related parts. Note that the blocks within the image processing unit 24 are constituted so as to be able to acquire all manner of data inside the image capturing apparatus including exposure parameters such as aperture value (F value), sensitivity value and shutter speed, through the system control unit 50.

In FIG. 2, a signal processing unit 201 acquires the video signal that is output from the image capturing unit 22 as image data via the A/D convertor 23 or the memory control unit 15, and performs generally widely known signal processing such as WB (white balance) processing and sharpness processing. A level conversion unit 202 converts the level of the image data that is output from the signal processing unit 201 to a signal level indicating absolute luminance and outputs the resultant image data. An output code conversion unit 203 converts the video signal having the absolute luminance level that is output from the level conversion unit 202 into a code value of the input signal of the display device and outputs the code value.

An exposure evaluation value generation unit 204 generates an evaluation value for extracting the luminance level of the video signal and performing exposure control which will be discussed later. A conversion factor calculation unit 205 calculates a conversion factor for converting the signal level that the image capturing unit 22 outputs to absolute luminance, based on shooting conditions such as aperture, shutter speed and sensitivity. The conversion factor calculated here is input to the level conversion unit 202, and is used in level conversion processing for converting the level of image data into a signal level indicating absolute luminance.

A conversion characteristics generation unit 206 acquires input/output characteristics of the display device that are stored in advance in the nonvolatile memory 56, the memory control unit 15 or the like, and generates a conversion table showing the relationship between the absolute luminance level of video that is displayed by the display device and the input code value of the display device (i.e., output code value of the digital video camera 100), based on the acquired input/output characteristics. The input/output characteristics of the display device may be recorded in advance in the nonvolatile memory 56 or may be set by inputs from the user, or the display device may be connected and the input/output characteristics acquired from the display device, and the acquisition method is not particularly limited.

The information that is generated by the conversion characteristics generation unit 206 is realized by a data array in table format representing the relationship of the input code value of the display device with the absolute luminance value that is displayed. The conversion table generated here is used in processing for converting the video signal of the absolute luminance level into an output code value that is performed by the output code conversion unit 203.

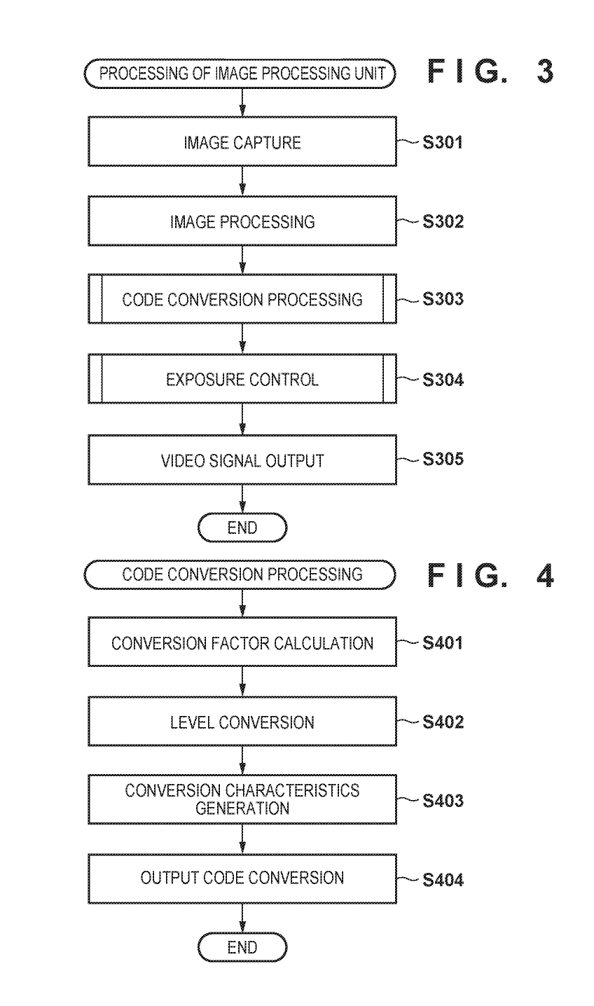

Next, operations of the image processing unit 24 constituted as described above will be described. FIG. 3 is a flowchart illustrating an image processing operation by the image processing unit 24 in the present embodiment. The flowchart shown in FIG. 3 is repeatedly performed whenever image capture is performed, and in the case of the NTSC video format, for example, is repeatedly executed in cycles of 60 Hz. Note that the respective processing of the flowchart of FIG. 3 is realized by programs stored in the nonvolatile memory 56 being expanded in the system memory 52, and the system control unit 50 executing those programs.

First, in step S301, the system control unit 50 controls the image capturing unit 22 to capture an object image formed through the taking lens 103. In step S302, the video signal captured with the image capturing unit 22 is converted into a digital signal by the A/D convertor 23, and input to the image processing unit 24. In the image processing unit 24, image processing such as WB processing and sharpness processing is performed.

In step S303, processing for converting the luminance level of the video signal that has undergone the above image processing into a code value corresponding to the absolute luminance level of the image to be displayed by the display device is performed in the image processing unit 24. This code conversion processing will be discussed in detail later. Note that although the present embodiment is described in terms of the code conversion processing of step S303 being performed on a signal that has undergone the image processing of step S302, the code conversion processing may be performed before the image processing, and the order of the image processing and the code conversion processing is not particularly limited.

Next, in step S304, exposure control is performed by the system control unit 50. The exposure amount controlled here is applied to images that are captured in frames from the next frame onward. Since the processing of this flowchart is repeatedly executed whenever image capture is performed, the result of the exposure control performed in prior frames will be reflected in the image capture processing that is executed in the current frame. Note that the contents of the exposure control will be discussed in detail later.

Next, in step S305, the image data that has undergone code conversion processing is output to the recording medium 90 or an external display device (not illustrated). Thus concludes the image capture processing of the image processing apparatus of the present embodiment.

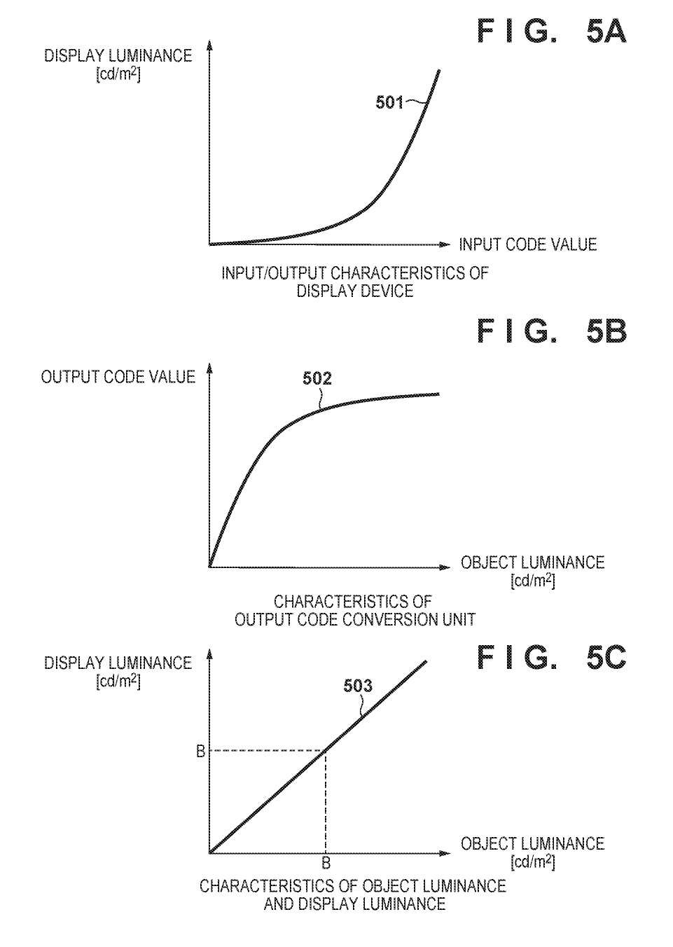

Next, operations of the code conversion processing performed in step S303 of the flowchart of FIG. 3 will be described. FIG. 4 is a flowchart illustrating operations of the code conversion processing of the present embodiment, and is called from the flowchart of FIG. 3 and executed.

First, in step S401, the conversion factor calculation unit 205 calculates the conversion factor for converting the signal level of the image data output from the image capturing unit 22 and converted into a digital signal by the A/D convertor 23 into absolute luminance. The conversion factor can be calculated based on shooting conditions such as aperture, shutter speed and sensitivity. An example of a method for calculating the conversion factor will be described below.

The conversion factor is a factor indicating the relationship between the object luminance (object luminance value) B [cd/m²] to be captured and the signal level that the image capturing unit 22 outputs when the object luminance is captured. A conversion factor L is calculated with the following equation, where a reference signal level, out of the signal levels that the image capturing unit 22 outputs, is given as Y_ref.

L=B/Y_ref (1)

Next, the object luminance B [cd/m²] is calculated. In the case where the aperture value in an APEX (Additive System of Photographic Exposure) expression is given as AV, exposure time is given as TV, sensitivity is given as SV, and object luminance is given as BV, the following equation holds.

AV+TV=BV+SV (2)

where

BV=Log₂(B [cd/m²]/(0.32·K)) (3)

and K is the calibration factor.

The object luminance B [cd/m²] is calculated by the following equation from equations (2) and (3).

B=0.32·K·2^{(AV+TV-SV)} (4)

Here, the sensitivity SV is determined in advance such that equation (4) holds when the output level of the image capturing unit 22 at the time that the object luminance B [cd/m²] is captured is the reference signal level. In the video camera of the present embodiment, as an example, a signal level corresponding to 18% standard neutral gray in the case where the video level maximum value is adjusted to a reflectance of 90% white is set as the reference signal level. Also, 12.5 is employed for the calibration factor K as an example.

Next, the reference signal level Y_ref is calculated. The reference signal level Y_ref differs depending on the dynamic range of the image capturing unit 22. In the case of having a dynamic range that is R times a video level of 100%, the reference signal level Y_ref is calculated as follows.

Y_ref=(2^{N})·(18/90)/R (5)

Here, N is the bit count of the signal.

In the video camera of the present embodiment, when the bit count N is set to 14 and the dynamic range R is set to 1200%, for example,

$$\begin{matrix}{Y}_{—} ref = ( {2}^{14} ) \times ( 20 \% \text{/} 1200 \% ) \\ = 273\end{matrix}$$

and a reference signal level Y_ref of 273 can be derived. The conversion factor L is calculated from the object luminance B of equation (4), the reference signal level Y_ref of equation (5) and equation (1). For example, in the case where the aperture is set to F4.0, the shutter speed is set to 1/128 seconds and the sensitivity is set to ISO 200, the conversion factor L can be calculated as follows from equations (4) and (1). Note that, in the case of using an ND filter, the conversion factor L is desirably included in one of the parameters.

$$\begin{matrix}B = 0.32 \times 12.5 \times {2}^{( 4 + 7 - 6 )} \\ = 128 [ cd \text{/} {m}^{2} ]\end{matrix}$$

$$\begin{matrix}L = 128 \text{/} 273 \\ = 0.469\end{matrix}$$

Next, in step S402 in the flowchart of FIG. 4, the level conversion unit 202 converts the signal level that is output from the image capturing unit 22 into absolute luminance using the conversion factor L. When an arbitrary signal level that is output from the image capturing unit 22 is given as Y, a signal level B_out after conversion will be calculated as follows.

B_out=L×Y (6)

Note that the method given here is one example, and the conversion factor L and the object luminance B may be derived by other methods. Also, the object luminance B may be calculated utilizing an external light measurement sensor, and the calculation method thereof is not limited in the present invention.

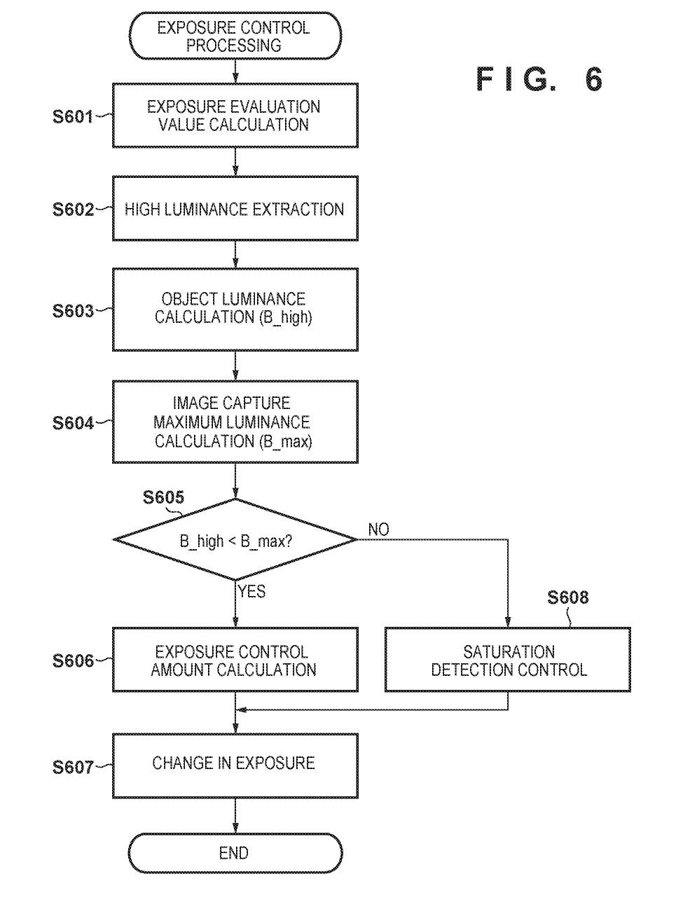

Next, in step S403, the conversion characteristics generation unit 206 calculates conversion characteristics for converting the video signal of absolute luminance calculated in step S402 into an input code value of the display device by the output code conversion unit 203. The display device in the present embodiment has a function of displaying input image data at an absolute luminance value corresponding to the input code value. The input/output characteristics (characteristics indicating the relationship between the input code value and the display luminance) are characteristics such as shown with a curve 501 in FIG. 5A. In the case of input/output characteristics of the display device such as shown in FIG. 5A, the output code value that the digital video camera 100 outputs need only be set to the inverse of the characteristics of FIG. 5A, as shows with a curve 502 in FIG. 5B. Accordingly, a function having characteristics such as shown in FIG. 5B is generated as the conversion table. As for the generation method, the conversion table may be derived by computation from the input/output characteristics of the display device of FIG. 5A, or may be calculated from an equation representing the input/output characteristics. Alternatively, a corresponding conversion table for every display device may be stored in advance in the nonvolatile memory 56 and the conversion table may be selected therefrom, and, in the present invention, there is no restriction on the determination method thereof. Note that since the display device in the present embodiment is able to display luminance values of the object with absolute luminance values, the values of the object luminance and the display luminance will coincide as shown with a straight line 503 in FIG. 5C.

Next, the conversion table generated in step S403 is transmitted to the output code conversion unit 203, and the image data converted into an absolute luminance level by the level conversion unit 202 is converted into an output signal for outputting to the display device. The conversion table is a finite number of table data having discrete values with respect to luminance levels, and is interpolated by linear interpolation, a high-order function or the like to obtain desired characteristics. The absolute luminance level of the video signal is converted into an output code according to these characteristics.

By performing code conversion processing in this manner, image data corresponding to absolute luminance that is displayed on the display device can be generated. In other words, it becomes possible to display the absolute luminance of the object on the display device at the original brightness, enabling a video having immediacy to be reproduced.

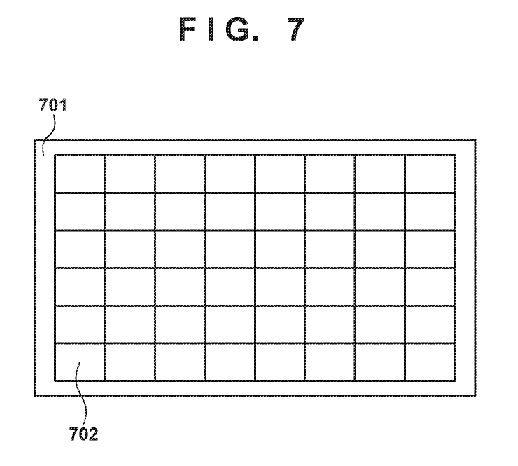

Next, operations of the exposure control processing, which is characteristic processing of the present embodiment, will be described. FIG. 6 is a flowchart showing operations of the exposure control processing of the present embodiment.

First, in step S601, the exposure evaluation value generation unit 204 extracts a luminance signal from the image data of the image capturing unit 22 obtained via the A/D convertor 23, and generates an exposure evaluation value to be used in exposure control. In generating the exposure evaluation value, the image data is divided into a plurality of areas, and information relating to luminance is generated for every area.

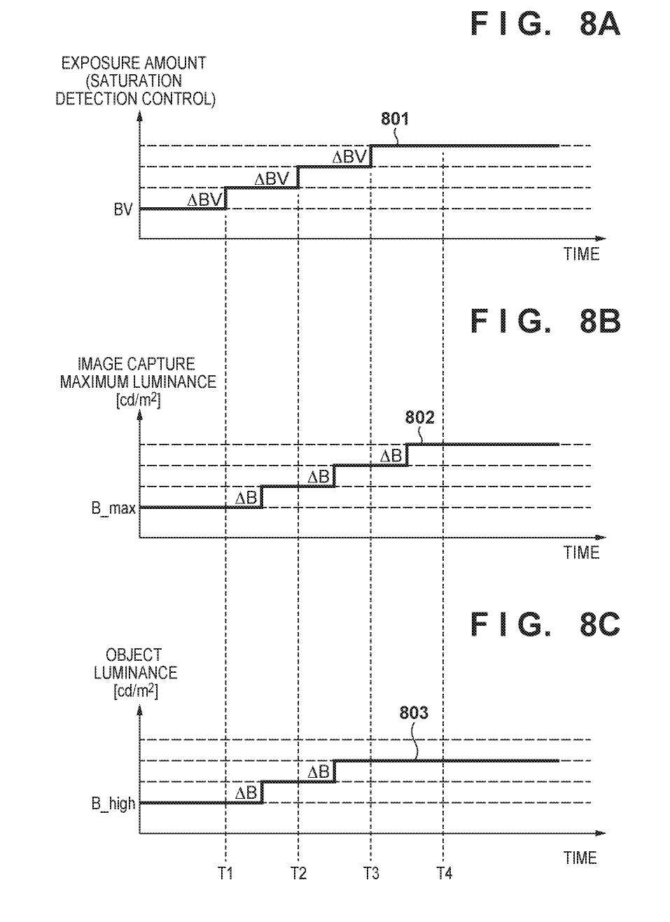

FIG. 7 is a diagram illustrating the state of the image data in the exposure evaluation value generation unit 204. In the exposure evaluation value generation unit 204, a total of 48 detection frames consisting of eight frames horizontally and six frames vertically as denoted by reference numeral 702 are disposed in the area of captured image data 701, and the average luminance is calculated for every detection frame. In step S602, the system control unit 50 acquires the average luminance of each detection frame from the exposure evaluation value generation unit 204, and extracts the maximum luminance level Y_high therefrom. In step S603, the maximum luminance value Y_high obtained in step S602 is converted into an absolute luminance B_high. In this conversion, the following computation is performed, using the aforementioned equation (1).

B_high=L×Y_high (8)

The conversion factor L is calculated from equations (1) and (4). For example, in the case where the aperture is F4.0, the shutter speed is 1/128 seconds, the sensitivity is ISO 200, and the reference signal level is 273 employing the aforementioned value, the conversion factor L is calculated as follows.

$$\begin{matrix}B = 0.32 \times 12.5 \times {2}^{( 4 + 7 - 6 )} \\ = 128 [ cd \text{/} {m}^{2} ]\end{matrix}$$

$$\begin{matrix}L = 128 \text{/} 273 \\ = 0.469\end{matrix}$$

When it is assumed the code value of the maximum luminance level Y_high is 8192 (in the case of 14 bits), the luminance B_high of the object will be derived as follows.

$$\begin{matrix}{B}_{—} high = 0.469 \times 8192 \\ = 3840 cd \text{/} {m}^{2}\end{matrix}$$

Next, in step S604, an image capture maximum luminance value B_max, which is the maximum luminance value capable of being captured with the image capturing unit 22, is calculated. As for the calculation method, the image capture maximum luminance can be easily calculated by multiplying the maximum value of the digital signal by the conversion factor L calculated in step S601. When the bit count N of image data is set to 14 bits and L=0.469,

$$\begin{matrix}{B}_{—} max = L \times {2}^{N} \\ = 0.469 \times {2}^{14} \\ = 7680 [ cd \text{/} {m}^{2} ]\end{matrix}$$

can be derived.

Next, in step S605, the object luminance B_high is compared with the image capture maximum luminance B_max. This processing is performed in order to determine whether the signal level is saturated, due to there being an object that is brighter than the maximum luminance capable of being captured with the image capturing unit 22. If the object luminance B_high is smaller than the image capture maximum luminance B_max, the signal level is not saturated, and thus the processing proceeds to step S606, and the exposure control amount is calculated. If the image capture maximum luminance B_max is substantially equal to the object luminance B_high, the signal level of the image capturing unit 22 could possibly be saturated, and thus the processing proceeds to step S608, and saturation detection control is performed. Note that because the signal level is saturated in the case where an object brighter than the image capture maximum luminance is captured, B_max<B_high does not occur.

If, in step S605, it is determined that B_high<B_max, the processing proceeds to step S606, and the system control unit 50 calculates the exposure control amount from the object luminance B_high and the image capture maximum luminance B_max. The purpose of calculating the exposure control amount here is to ensure that a tone deficiency does not occur, by deriving an exposure control amount that adjusts the image capture maximum luminance B_max according to the high luminance portion (object luminance B_high) of the object. An exposure control amount ΔBV in the APEX expression

$$\begin{matrix}Δ BV = {Log}_{2} ( {B}_{—} high \text{/} {B}_{—} max ) \\ = {Log}_{2} ( 3840 \text{/} 7680 ) \\ = - 1.0\end{matrix} \qquad ( 9 )$$

is derived. In step S607, exposure control is performed based on the exposure control amount ΔBV derived in step S604. An objective value BV_target of exposure need only be obtained by adding ΔBV to a current exposure value BV_now.

BV_target=BV_now+ΔBV (10)

Because BV can be represented as shown in equation (2), the value of BV can be changed by changing any of AV, TV and SV. In the present embodiment, ΔBV is added to AV as an example. The current AV=4 (F4.0) is changed by ΔBV=−1 (−1 stop), and AV=3 (F2.8) after the change serves as the target value of exposure control. The system control unit 50 controls the aperture 101 to be F2.8. Note that, in the exposure control processing of moving image capture, exposure control processing is executed whenever image capture is performed. Control is performed such that ΔBV is divided into a plurality of frames and the target exposure is gradually attained over plurality of frames (such that the image capture maximum luminance value becomes greater than or equal to the object luminance value). Accordingly, BV_now and ΔBV are updated whenever exposure control processing is executed, and ultimately BV_now converges to BV_target.

Next, the operation of step S608 that is executed in the case where it is determined that the object luminance B_high is substantially equal to the image capture maximum luminance B_max in step S605 will be described. In the case where step S608 is executed, the signal level of the image capturing unit 22 could possibly be saturated. Because luminance of a brightness that exceeds the image capture maximum luminance B_max cannot be detected at that time, the object luminance B_high cannot be correctly calculated. Thus, exposure control for saturation detection (hereinafter, called saturation detection control) that differs from the aforementioned exposure control of step S606 is executed. The control referred to here is control for changing the exposure by a predetermined amount and ending the processing of that frame, and repeatedly performing similar processing in the processing of the next frame onward. Here, it is assumed that saturation detection control is executed at an interval of once every ten frames, for example.

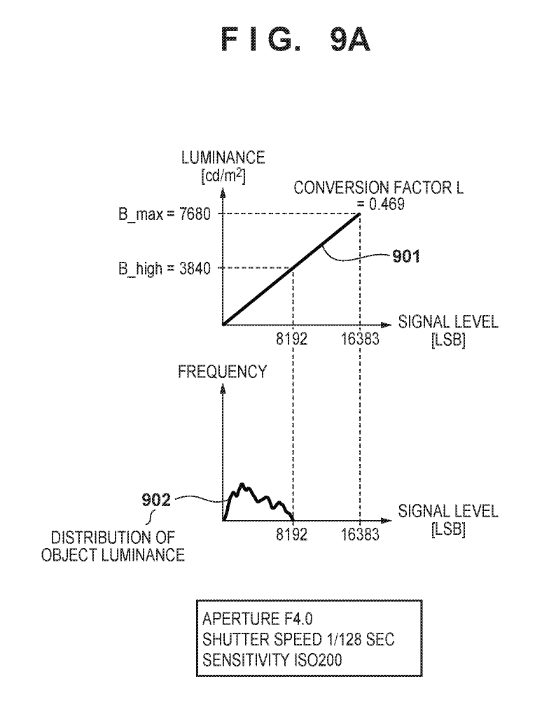

Saturation detection control will be described in detail with reference to FIGS. 8A to 8C. Reference numeral 801 in FIG. 8A denotes a graph representing change through time in the exposure amount BV at the time of saturation detection control. When it is determined that the object luminance B_high is substantially equal to the image capture maximum luminance B_max at the time of time T1, saturation detection control is started. A very small predetermined exposure amount ΔBV is added to the exposure amount BV at this time to change the exposure. ΔBV is set to an exposure amount of a ⅛ stop, for example. Reference numeral 802 in FIG. 8B denotes a graph showing the change in the image capture maximum luminance B_max. Also, reference numeral 803 in FIG. 8C denotes a graph showing the change in the object luminance B_high.

The exposure amount changed at time T1 is reflected in images that are captured several frames later, and changes in a direction in which the image capture maximum luminance increase from B_max by a luminance change amount ΔB corresponding to ΔBV. At time T2 which is ten frames after time T1, the image capture maximum luminance B_max is compared with the object luminance B_high. At time T2, the image capture maximum luminance has increased by ΔB. At this time, as is evident from FIG. 8C, the object luminance B_high has increased by the same ΔB, and the object luminance B_high could possibly be greater than the image capture maximum luminance B_max. Accordingly. ΔBV is further added to the exposure amount, and the image capture maximum luminance B_max is increased by ΔB. At time T3 which is a further ten frames after time T2, the image capture maximum luminance B_max is similarly compared with the object luminance B_high. Here again, as is evident from FIG. 8C, the object luminance B_high has increased by the same amount as the increase ΔB in the image capture maximum luminance B_max. Thus, ΔBV is further added to the exposure amount. A similar determination is performed at time T4 which is a further ten frames after time T3. At time T4, as is evident from FIG. 8C, the object luminance B_high has not changed from time T3 in response to the increase ΔB in the image capture maximum luminance B_max. That is, the object luminance B_high will be less than or equal to the image capture maximum luminance B_max, and the object luminance B_high can now be correctly detected. The saturation detection control is then ended at time T4.

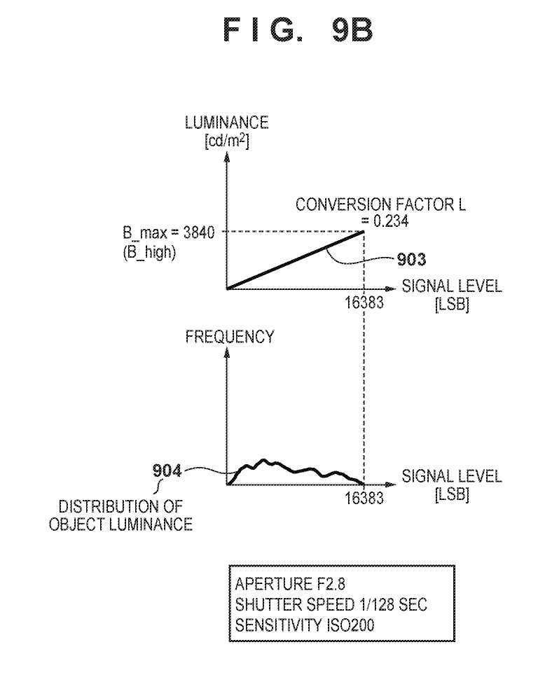

The effects obtained by performing control as described above will be described using FIGS. 9A and 9B. FIGS. 9A and 9B are graphs illustrating the signal level that the image capturing unit 22 outputs, absolute luminance of the object, and the image capture maximum luminance B_max. The horizontal axis is the signal level that the image capturing unit 22 outputs, with the maximum level being 16383 (in the case where the bit count is 14 bits). The absolute luminance value corresponding to the signal level is shown on the vertical axis. Also, in the lower diagrams of FIGS. 9A and 9B, the horizontal axis shows the signal level and the vertical axis shows the number of detection frames 702 of FIG. 7 having that signal level as an average value. In other words, the diagrams below FIGS. 9A and 9B show the luminance distribution of the object.

FIG. 9A shows the relationship between absolute luminance and signal level in the case where the aperture value is F4.0, the shutter speed is 1/128 seconds, and the sensitivity is ISO 200. Reference numeral 901 in FIG. 9A denotes the conversion factor, and is L=0.469 in the case of the above exposure parameters. The image capture maximum luminance B_max is 7680 [cd/m²]. Reference numeral 902 in the lower diagram of FIG. 9A denotes the luminance distribution of the object, and the maximum luminance B_high of the object corresponding to the maximum signal level 8192 of the object is 3840 [cd/m²] as shown in the upper diagram of FIG. 9A. In the case of capturing such an object, the image capture maximum luminance B_max is controlled by the exposure control of the present embodiment so as to approach the maximum luminance B_high of the object.

FIG. 9B is a graph illustrating the situation after using aperture to control the change in the exposure amount ΔBV=−1 from the state of FIG. 9A. By changing the aperture value by ΔBV=−1 (stop), the aperture value is changed to F2.8, and the shutter speed and the sensitivity will respectively be 1/128 seconds and ISO 200. At this time, the conversion factor that is denoted by reference numeral 903 in the upper diagram of FIG. 9B changes to L=0.234, and the maximum signal level of the object in the lower diagram of FIG. 9B changes from 8192 to 16383. The image capture maximum luminance B_max corresponding to the maximum signal level 16383 of the object will then be 3840 as shown in the upper diagram of FIG. 9B. In other words, in the case where the same object as FIG. 9A is being captured, the luminance of the object will be distributed to the maximum level that the image capturing unit 22 is capable of capturing as shown with reference numeral 904 in the lower diagram of FIG. 9B.

More specifically, in FIG. 9A, the maximum luminance B_high of the object being captured is 3840 [cd/m²] relative to an image capture maximum luminance B_max of 7680 [cd/m²]. That is, the range of 8192 to 16383 corresponding to the signal level of the image capturing unit 22 is not used, and the bit width of the signal is allocated unnecessarily. In other words, tonality drops. In contrast, in FIG. 9B, exposure is controlled so as to use the signal levels of the image capturing unit 22 evenly according to the luminance of the object that is being captured. By performing controlling in this way, blown out highlights do not occur in the high luminance portion of the object, and a drop in tonality can be prevented. Note that in the above control, the exposure parameters are changed to change to the exposure so as to attain the state of FIG. 9B from the state of FIG. 9A. However, in the digital video camera 100 of the present embodiment, the objective is to display the object with absolute luminance on the display device, and thus the brightness of the image on the display device is not changed, and the image can be displayed at the original brightness.

Also, in the above, it was described that the image capture maximum luminance B_max is adjusted according to the maximum luminance B_high of the object. However, exposure control may be performed such that a reference luminance value that serves as a reference between the minimum absolute luminance and the maximum absolute luminance of the object corresponds to a position that serves as a reference over the range of signal levels capable of being captured with the image capturing unit 22. For example, exposure may be controlled such that a central luminance value between the minimum absolute luminance and the maximum absolute luminance of the object coincides with the central signal level between the minimum and maximum signal levels that are obtained by the image capturing unit 22.

### Second Embodiment

In the first embodiment, an example of a method for controlling exposure, in the case of displaying an object image with absolute luminance on a display device, so as to adjust the image capture maximum luminance of the image capturing unit 22 according to the object luminance was illustrated. However, in the case where the image capture maximum luminance is controlled to be in a luminance range that exceeds the luminance range capable of being output by the display device, a luminance range that cannot actually be displayed by the display device is covered, and the use efficiency of the signal level drops, leading to a drop in tonality. As a countermeasure, a method for controlling the image capture maximum luminance so as to not exceed the maximum luminance capable of being displayed by the display device is conceivable. Also, the displayable luminance range generally differs depending on the display device. Thus, the image capture maximum luminance is desirably set to an arbitrary luminance that the user wants. In the second embodiment, this method will be described.

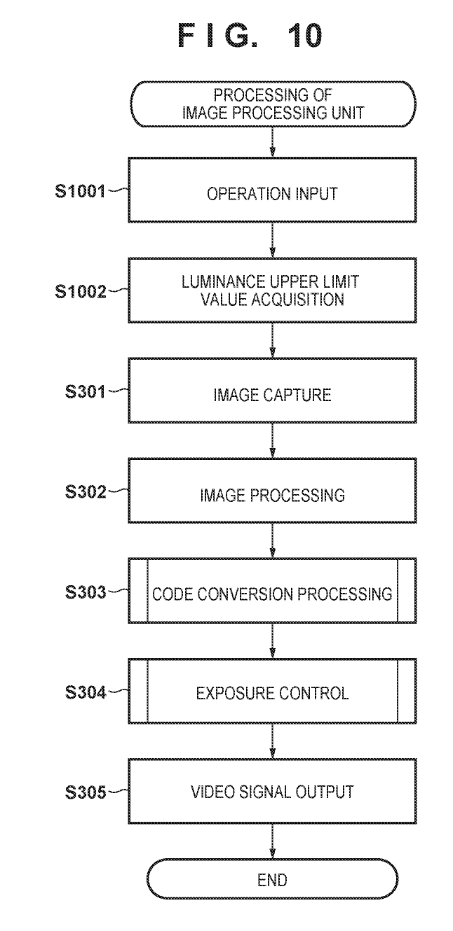

Since the configuration of the digital video camera 100 is similar to the configuration of the first embodiment shown in FIGS. 1 and 2, description thereof will be omitted. Hereinafter, only the differences from the first embodiment will be described. FIG. 10 is a flowchart showing operations of an image processing unit 24 in the present embodiment. Note that similar processing to the first embodiment is given similar reference signs to FIG. 3 showing the operations of the first embodiment, and description thereof will be omitted.

Operations of the image processing unit in the second embodiment will be described with reference to the flowchart of FIG. 10.

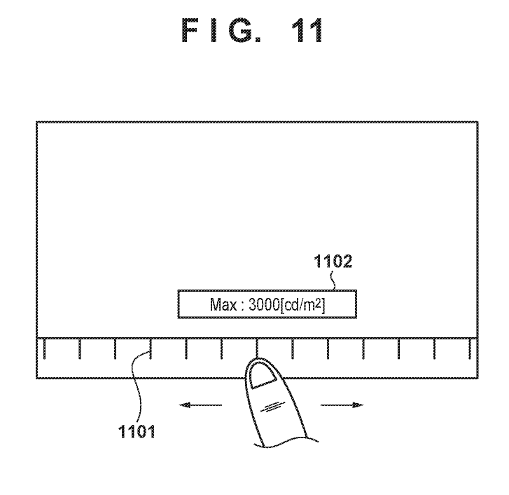

First, in step S1001, operation information of the user is acquired. Here, a user interface such as shown in FIG. 11 is displayed on the display unit 28.

The user is able to set an upper limit value 1102 of the luminance range to an arbitrary value, by moving a scale 1101 right and left while viewing the display screen. The upper limit value of this luminance range that is set is transmitted to a system control unit 50, and the system control unit 50 changes the upper limit value (limit value) of the luminance range (adjustable range) that is being held.

Next, in step S1002, an image capture maximum luminance upper limit value B_max_limit which is the upper limit value of the image capture maximum luminance B_max is determined. The upper limit value of the luminance range acquired in step S1001 is converted into a numerical value and set as B_max_limit. B_max_limit is referred to in the exposure control of step S304.

Steps S301 to S303 and S305 of FIG. 10 are similar to the first embodiment, and thus description thereof will be omitted. Exposure control is performed in step S304. Operations of the exposure control processing are realizable with similar processing to the flowchart shown in FIG. 6. Steps S601 to S607 are similar to the first embodiment, and thus description thereof will be omitted. The saturation detection control of step S608 is processing for controlling the image capture maximum luminance B_max in a direction that increases brightness.

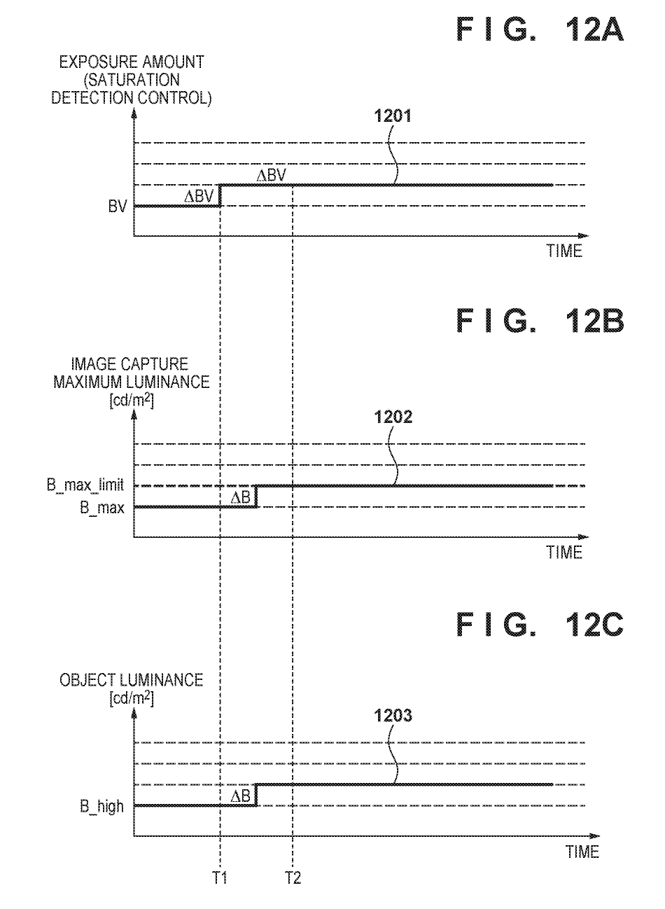

The saturation detection control of the second embodiment will be described with reference to the timing charts of FIGS. 12A to 12C.

Reference numeral 1201 in FIG. 12A denotes a graph representing the change through time in the exposure amount at the time of saturation detection control. At time T1, saturation detection control is started when it is determined that an object luminance B_high is substantially equal to the image capture maximum luminance B_max. A predetermined exposure control amount ΔBV is added to the exposure amount BV at this time to change the exposure. ΔBV is set to an exposure amount of a ⅛ stop, for example. Reference numeral 1202 in FIG. 12B denotes a graph showing the change in the image capture maximum luminance B_max. Also, Reference numeral 1203 in FIG. 12C denotes a graph showing the change in the object luminance B_high. The exposure amount changed at time T1 is reflected in images that are captured several frames later, and changes in a direction in which the image capture maximum luminance increases from B_max by a luminance change amount ΔB corresponding to an exposure control amount ΔBV.

At time T2 which is ten frames after time T1, the image capture maximum luminance B_max is then compared with the object luminance B_high. At time T2, the image capture maximum luminance B_max has increased by ΔB. At this time, as is evident from FIG. 12C, the object luminance B_high increases by the same ΔB, and the object luminance B_high could possibly be larger than the image capture maximum luminance B_max. In the first embodiment, the exposure control amount ΔBV is further added here, whereas, in the second embodiment, the image capture maximum luminance B_max is compared with the image capture maximum luminance upper limit value B_max_limit, and B_max is controlled so as to not exceed B_max_limit. In FIG. 12B, since B_max already coincides with B_max_limit at time T2, saturation detection control is ended without performing control for adding ΔBV at time T2.

By performing control in this way, it becomes possible to control the image capture maximum luminance, by setting a luminance value arbitrarily set by an instruction from the user as the upper limit. Controlling the image capture maximum luminance to be in a luminance range that exceeds the luminance range capable of being output by the display device will thereby no longer occur, and a drop in tonality can be prevented.

### Third Embodiment

In the first embodiment, an example of a method for controlling exposure, in the case of displaying an object image with absolute luminance on a display device, so as to adjust the image capture maximum luminance B_max of the image capturing unit 22 according to the object luminance was illustrated. In the present embodiment, another example of a method for controlling exposure at the time of adjusting the image capture maximum luminance B_max will be described. In the first embodiment, saturation detection control needs to be performed, when the object luminance B_high is substantially equal to the image capture maximum luminance B_max. In this embodiment, a method for avoiding saturation with a simpler control will be described.

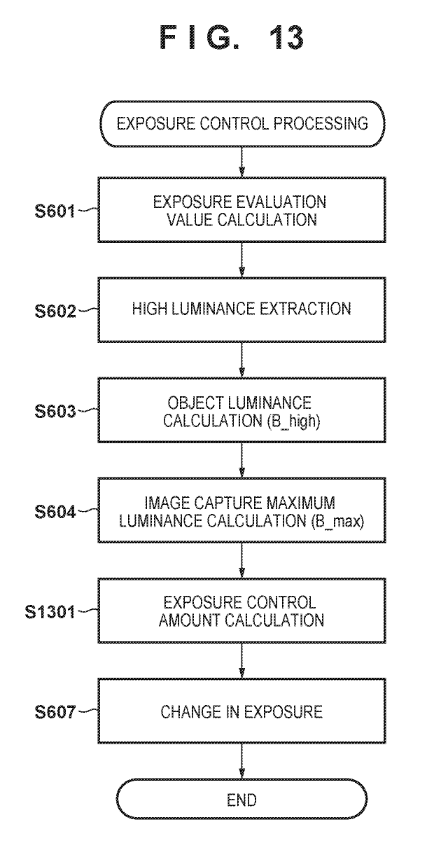

Since the configuration of a digital video camera 100 is similar to the configuration of the first embodiment shown in FIGS. 1 and 2, description thereof will be omitted. Hereinafter, only the differences from the first and second embodiments will be described. Operations of an image processing unit of the present embodiment are realizable with similar processing to the flowchart of FIG. 10 of the second embodiment. The operations of exposure control processing will be described using the flowchart of FIG. 13. Similar processing to the flowchart of FIG. 6 showing the exposure control processing in the first embodiment is given the same reference signs and description thereof will be omitted. In the flowchart of FIG. 13, steps S605 and S608 of FIG. 6 are deleted, and step S1301 is provided instead of the exposure control amount calculation of step S606.

In step S1301, the exposure control amount is calculated from the object luminance B_high and the image capture maximum luminance B_max. In the first embodiment, the exposure control amount ΔBV is calculated using equation (9), whereas, in the present embodiment, the exposure control amount ΔBV is calculated using equation (11). In the control according to equation (9) of the first embodiment, exposure is controlled by deriving an exposure control amount at which the image capture maximum luminance B_max is substantially equal to the object luminance B_high. Thus, an object luminance that exceeds the image capture maximum luminance B_max could not be detected, and saturation detection control was required. In the present embodiment, control for avoiding saturation with simple control instead of saturation detection control is performed.

The exposure control amount ΔBV is calculated by the following equation (11).

ΔBV=Log₂(B_high·B_coef/B_max) (11)

Here, when B_coef is set to 1.2, for example,

ΔBV=Log₂(3840×1.2/7680)=−0.74

ΔBV can be calculated in this way. This exposure control amount ΔBV is an exposure control amount at which the image capture maximum luminance B_max attains a brightness that is 1.2 times the value of B_high, rather than an exposure control amount at which the image capture maximum luminance B_max is substantially equal to the object luminance B_high. That is, exposure is controlled to allocate the object luminance to 1/1.2≈83% (predetermined percentage) of the maximum value of the signal level, rather than allocating the object luminance so as to use all of the signal levels up to the maximum value of the signal level of the image capturing unit 22.

By performing control in this way, in the case where the object luminance is from 83% to 100% of the maximum value of the signal level of the image capturing unit 22, control such as making the exposure darker becomes possible, and the saturation detection control of the first embodiment will be unnecessary. Although the tonality drops slightly in comparison with the first embodiment, exposure control can be realized with simpler control.

Although the present invention has been described in detail based on preferred embodiments thereof, the invention is not limited to these specific embodiments, and various modes within a range that does not depart from the spirit of the invention are also included in the present invention. Parts of the abovementioned embodiments may be appropriately combined.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-130519, filed Jul. 3, 2017 which is hereby incorporated by reference herein in its entirety.

What is claimed is:

1. An image capturing apparatus comprising:
at least one processor or circuit configured to perform the operations of the following units:
an image capturing unit configured to capture an image of an object;
a calculation unit configured to extract a maximum luminance value of the object from an image signal that is output from the image capturing unit, and to calculate an object luminance value representing the maximum luminance value of the object with absolute luminance; and
an exposure control unit configured to control exposure of the image capturing unit such that an image capture maximum luminance value, which is a maximum value of the absolute luminance capable of being captured with the image capturing unit, is greater than or equal to the object luminance value.

2. The image capturing apparatus according to claim 1,
wherein the exposure control unit controls exposure of the image capturing unit such that the image capture maximum luminance value is slightly larger than the object luminance value.

3. The image capturing apparatus according to claim 1,
wherein the exposure control unit controls exposure to become darker in a case where the object luminance value is larger than the image capture maximum luminance value, and controls exposure to become lighter in a case where the object luminance value is smaller than the image capture maximum luminance value.

4. The image capturing apparatus according to claim 1,
wherein the exposure control unit, in a case where the object luminance value and the image capture maximum luminance value substantially coincide, acquires the object luminance value that is taken when an exposure amount is changed slightly, and, in a case where the object luminance value changes in response to the change in the exposure amount, controls the exposure to become darker.

5. The image capturing apparatus according to claim 1,
wherein the exposure control unit controls an exposure amount such that the object luminance value takes a luminance value obtained by multiplying the image capture maximum luminance value by a predetermined rate.

6. The image capturing apparatus according to claim 1,
wherein the exposure control unit changes a limit value defining a range over which the image capture maximum luminance value is adjustable, according to a user instruction.

7. The image capturing apparatus according to claim 1,
wherein the exposure control unit changes the exposure, by changing one of an aperture value, a sensitivity value, a shutter speed and a presence/absence of an ND filter.

8. The image capturing apparatus according to claim 1,
wherein the calculation unit divides the image signal into a plurality of areas, and extracts the maximum luminance value of the object, from a signal level of each area.

9. The image capturing apparatus according to claim 8,
wherein the calculation unit extracts the maximum luminance value of the object, based on an average value of the signal level of the plurality of areas.

10. The image capturing apparatus according to claim 1,
therein the calculation unit calculates the object luminance value, based on at least an aperture value, a shutter speed, a sensitivity value and the maximum luminance value of the object that are set when the object is captured by the image capturing unit.

11. The image capturing apparatus according to claim 1, wherein the at least one processor or circuit is configured to further perform the operations of
a conversion unit configured to convert the image signal so as to take an inverse of input/output characteristics of a display unit configured to display the image signal.

12. An image capturing apparatus comprising:
at least one processor or circuit configured to perform the operations of the following units:
an image capturing unit configured to capture an image of an object;
a calculation unit configured to extract a reference luminance value of the object from an image signal that is output from the image capturing unit, and to calculate an object luminance value representing the reference luminance value of the object with absolute luminance; and
an exposure control unit configured to control exposure of the image capturing unit, such that a position of the object luminance value between a minimum absolute luminance value and a maximum absolute luminance value of the object substantially coincides with a position of the object luminance value between a minimum value and a maximum value of an absolute luminance value capable of being captured with the image capturing unit.

13. A method for controlling an image capturing apparatus that includes an image capturing unit configured to capture an image of an object, the method comprising:
extracting a maximum luminance value of the object from an image signal that is output from the image capturing unit, and calculating an object luminance value representing the maximum luminance value of the object with absolute luminance; and
controlling exposure of the image capturing unit such that an image capture maximum luminance value, which is a maximum value of the absolute luminance capable of being captured with the image capturing unit, is greater than or equal to the object luminance value.

14. A method for controlling an image capturing apparatus that includes an image capturing unit configured to capture an image of an object, the method comprising:
extracting a reference luminance value of the object from an image signal that is output from the image capturing unit, and calculating an object luminance value representing the reference luminance value of the object with absolute luminance; and
controlling exposure of the image capturing unit, such that a position of the object luminance value between a minimum absolute luminance value and a maximum absolute luminance value of the object substantially coincides with a position of the object luminance value between a minimum value and a maximum value of an absolute luminance value capable of being captured with the image capturing unit.

15. A computer-readable storage medium storing a computer program for causing a computer to execute a control method of an image capturing apparatus that includes an image capturing unit configured to capture an image of an object, the method comprising:
extracting a maximum luminance value of the object from an image signal that is output from the image capturing unit, and calculating an object luminance value representing the maximum luminance value of the object with absolute luminance; and
controlling exposure of the image capturing unit such that an image capture maximum luminance value, which is a maximum value of the absolute luminance capable of being captured with the image capturing unit, is greater than or equal to the object luminance value.

16. A computer-readable storage medium storing a computer program for causing a computer to execute a control method of an image capturing apparatus that includes an image capturing unit configured to capture an image of an object, the method comprising:
extracting a reference luminance value of the object from an image signal that is output from the image capturing unit, and calculating an object luminance value representing the reference luminance value of the object with absolute luminance; and
controlling exposure of the image capturing unit, such that a position of the object luminance value between a minimum absolute luminance value and a maximum absolute luminance value of the object substantially coincides with a position of the object luminance value between a minimum value and a maximum value of an absolute luminance value capable of being captured with the image capturing unit.
